(19) United States
(12) Patent Application Publication
(10) Pub. No.: US 2008/0117813 A1
(43) Pub. Date: May 22, 2008

(54) METHOD AND SYSTEM FOR DYNAMIC RATE-LIMITING IN SWITCH

(75) Inventors: Hyun Yong HWANG, Daejeon-City (KR); Dae Geun Park, Daejeon-City (KR); Bhum Cheol Lee, Daejeon-City (KR); Jeong Hee Lee, Daejeon-City (KR); Seung Woo Lee, Seoul (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/937,805

(22) Filed: Nov. 9, 2007

(30) Foreign Application Priority Data
Nov. 17, 2006 (KR) 10-2006-0114094

(51) Int. Cl. H04L 12/56

(52) U.S. Cl. 370/230

(57) ABSTRACT

Provided is a dynamic rate-limiting method and apparatus used in a switch for switching packets from input ports to output ports, the method including: (a) adding traffic bandwidth values set in advance in active subscribers that are using the switch from among subscribers connected to the switch; (b) comparing the added value with a range between a maximum bandwidth and a minimum bandwidth that are set in the switch; and (c) according to a result of comparing, when the added values is smaller than the minimum bandwidth or larger than the maximum bandwidth set in the switch, increasing or decreasing the traffic bandwidths of the active subscribers set in advance so that the added value is within the range between the maximum bandwidth and minimum bandwidth. Accordingly, it is possible to automatically control the traffic bandwidths of subscribers that are currently using the switch.

### CROSS-REFERENCE TO RELATED PATENT APPLICATION

This application claims the benefit of Korean Patent Application No. 10-2006-0114094, filed on Nov. 17, 2006, in the Korean Intellectual Property Office, the disclosure of which is incorporated herein in its entirety by reference.

### BACKGROUND OF THE INVENTION

1. Field of the Invention

The present invention relates to a dynamic rate-limiting method and apparatus used in a switch for switching packets from input ports to an output port, and more particularly, to a method of automatically controlling a rate limit value by comparing a bandwidth of input traffic currently being used in a switch with an allowable switch output capacity.

This work was supported by the IT R&D program of MIC/IITA [2005-S-052-02, Multi-service Switch Development]

2. Description of the Related Art

Currently, in order to actively connect a plurality of subscribers in a subscriber network, the use of a switch having advantages in terms of a flexible bandwidth guarantee and extensibility of network implementation is required. Each Internet service subscriber requires different traffic bandwidth according to the use of an Internet service. An Internet service provider (ISP) considers that payment denomination is based on the magnitude of traffic/bandwidth usage. Therefore, in the subscriber network connecting each of the subscribers based on a switch, a dynamic rate-limiting method capable of guarantying the traffic/bandwidth usage by a usage contract between the ISP and the Internet service subscribers and capable of actively controlling traffic of the subscribers according to current traffic is required.

FIG. 1 is a structural view showing a system implementing a rate-limiting method of a general switch. Referring to FIG. 1, the general switch includes an input port 110, an input port logic 120, a switch fabric 130, an output port logic 140, and an output port 150.

The input port logic 120 includes a rate-limiting filter 160 having a function of controlling the bandwidth of traffic and an input controller 170 for controlling the rate-limiting filter 160.

The output port logic 140 includes a traffic monitor 180 for measuring the bandwidth of traffic transmitted through the output port 150 and an output controller 190 for informing the input port logic 120 of an overload on the output port logic 140.

The rate-limiting method of the general switch is described as follows. Packets input to the input port 110 are output through the input port logic 120, the switch fabric 130, and the output port logic 140 to the output port 150. When a traffic overload occurs on the output port logic 140, the traffic monitor 180 informs the output controller 190 of congestion. The output port controller 190 transmits flow control information to the input port controller 170. The input port controller 170 removes a part of packets that are transmitted through the rate-limiting filter 160 to the output port 150.

The rate-limiting method applied to the general switch has the following problems.

First, in the general switch structure, since the input port logic 120 has to process not only packets that are normally transmitted to the output port 150 but also packets that are to be removed due to congestion in the output port 150, the input port logic 120 has an unnecessary load.

Second, in the general switch structure, when the input port logic 120 receives from the output port logic 140 flow control information informing that there is traffic congestion, the input port logic 120 has to selectively remove only packets that are to be transmitted to the output port 150, and thus the input port logic 120 has a complex structure in order to be able to store and manage the packets for each output port 150.

Last, in the general switch structure, the switch fabric 130 also has to process not only the packets that are normally transmitted to the output port 150 but also the packets that are to be removed due to the congestion in the output port 150, and therefore the switch fabric 130 is inefficient.

Accordingly, the development of an efficient rate-limiting method of automatically controlling rate-limiting traffic that is allocated to subscribers that are currently using the switch according to the total current traffic and removing in advance in the input port overload induction traffic that causes the congestion in the output port in order to overcome the inefficiency that occurs in a structure for transmitting the flow control information from the output port, is required.

### SUMMARY OF THE INVENTION

The present invention provides a method of monitoring input traffic input to a switch input port for a predetermined time, and predicting in advance by a switch input port the possibility of congestion in a switch output port by using rate-limiting traffic information that is set for subscribers that are currently using the switch, thereby automatically increasing or decreasing rate-limiting traffic.

According to an aspect of the present invention, there is provided a dynamic rate-limiting method used in a switch for switching packets from input ports to an output port, the method including: (a) adding traffic bandwidth values set in advance in active subscribers that are using the switch from among subscribers connected to the switch; (b) comparing the added value with a range between a maximum bandwidth and a minimum bandwidth that are set in the switch; and (c) according to a result of comparing, when the added values is smaller than the minimum bandwidth or larger than the maximum bandwidth set in the switch, increasing or decreasing the traffic bandwidths of the active subscribers set in advance so that the added value is within the range between the maximum bandwidth and minimum bandwidth.

In the above aspect of the present invention, in (a), a subscriber of the subscribers connected to the switch may be connected to each of the input ports, or several subscribers may be connected to a single input port.

In addition, the method may further include, before (a), (a-0) setting the traffic bandwidths of the subscribers connected to the switch as predetermined initial values.

In addition, the method may further include, the (a), (a-1) monitoring the input traffic of subscribers from among the subscribers connected to the switch for a predetermined period of time to determine the active subscribers that have the input traffic.

In addition, (c) may return to (a) after increasing or decreasing the traffic bandwidths of the active subscribers.

In addition, in (c), traffic bandwidths of the active subscribers may be increased or decreased to values obtained by distributing the maximum value of a total traffic rate range of the switch at a predetermined ratio according to the number of the active subscribers.

According to another aspect of the present invention, there is provided a dynamic rate-limiting apparatus used in a switch for switching packets from input ports to an output port, the apparatus including: a rate calculating unit adding all of traffic bandwidth values set in advance in active subscribers that are using the switch from among subscribers connected to the switch; a rate comparing unit comparing the added value with a range between a maximum bandwidth and a minimum bandwidth that are set in the switch; and a rate setting unit increasing or decreasing the traffic bandwidths of the active subscribers set in advance so that the added value is within the range between the maximum bandwidth and minimum bandwidth set in the switch when the added value is smaller than the minimum bandwidth or larger than the maximum bandwidth set in the switch according to a result of comparing.

In the above aspect of the present invention, in the rate calculating unit, a subscriber of the subscribers connected to the switch may be connected to each of the input ports, or several subscribers may be connected to a single input port.

In addition, the apparatus may further include a rate initializing unit setting the traffic bandwidths of the subscribers connected to the switch as predetermined initial values.

In addition, the apparatus may further include a subscriber determining unit monitoring the input traffic of subscribers from among the subscribers connected to the switch for a predetermined period of time to determine the active subscribers that have the input traffic.

In addition, in the rate setting unit operation may return to the subscriber determining unit after increasing or decreasing the traffic bandwidths of the active subscribers.

In addition, the rate setting unit may increase or decrease the traffic bandwidths of the active subscribers to values obtained by distributing a maximum value of a total traffic rate range of the switch at a predetermined ratio according to the number of the active subscribers.

### BRIEF DESCRIPTION OF THE DRAWINGS

The above and other features and advantages of the present invention will become more apparent by describing in detail exemplary embodiments thereof with reference to the attached drawings in which:

FIG. 1 is a structural view showing a system for implementing a rate-limiting method used in a general switch;

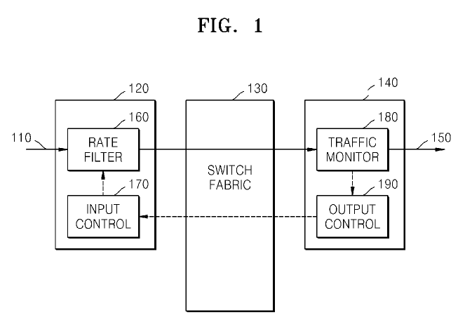

FIG. 2 is a flowchart of a rate-limiting method used in a switch and a view showing changes according to a period of time, according to an embodiment of the present invention;

FIG. 3 is a structural view showing a system for implementing a rate-limiting method used in a switch, according to an embodiment of the present invention; and

FIG. 4 is a flowchart of a method of limiting the traffic bandwidths of active subscribers, according to an embodiment of the present invention.

### DETAILED DESCRIPTION OF THE INVENTION

Hereinafter, exemplary embodiments of the present invention will be described in detail with reference to the attached drawings.

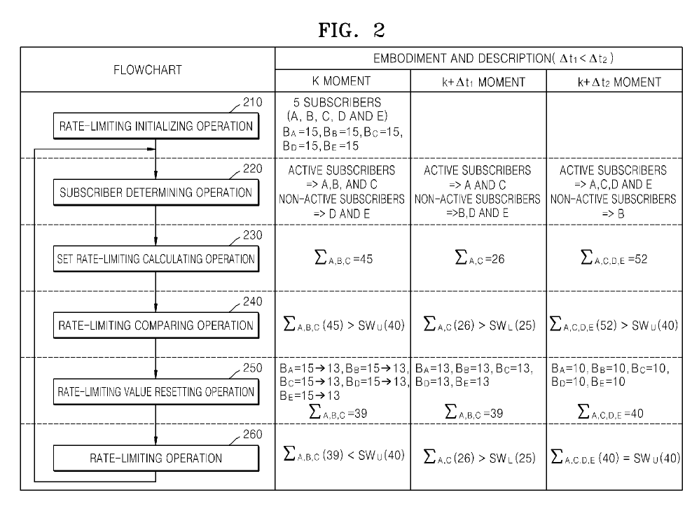

FIG. 2 is a flowchart of a rate-limiting method used in a switch and a view showing changes according to a period of time, according to an embodiment of the present invention.

A switch performs a rate-limiting initializing operation by setting an initial value of a rate-limiting value for each subscriber that uses the switch (operation 210). The switch performs a subscriber determining operation by monitoring input traffic of subscribers connected to the switch after a predetermined time and classifying all the subscribers into active subscribers that are currently using the switch and non-active subscribers that are not currently using the switch (operation 220).

The switch performs a set rate-limiting calculating operation by adding all set rate-limiting values of the active subscribers that are classified in the subscriber determining operation (operation 230). The switch performs a rate-limiting comparing operation by comparing a sum of the set rate-limiting values of the active subscribers added in the set rate-limiting calculating operation with an allowable reference rate between a switch upper-limit (SWU) and a switch lower-limit (SWL) in consideration of throughput and congestion of the switch (operation 240).

The switch performs a rate-limiting value resetting operation by resetting a rate-limiting value of each of the active subscribers according to a result of the rate-limiting comparing operation 240 in order to optimally use the switch even the throughput of the switch without congestion occurring in the switch (operation 250).

The switch performs a rate-limiting operation by controlling a rate of the active subscriber as a rate-limiting value set in the rate-limiting resetting operation 250 by measuring traffic of the active subscribers and returning to the subscriber determining operation 220 (operation 260).

Next, an embodiment of a switch applying an embodiment of the present invention in relation to the flowchart illustrated in FIG. 2 will be described. It is assumed that, the switch has five input ports and an output port. The input ports are connected to subscribers A, B, C, D, and E. The SWU and SWL, in consideration of the throughput and congestion of the switch, are 40 and 25, respectively.

At a specific time k, the switch sets a rate-limiting value to 15 for all the subscribers in the rate-limiting initializing operation 210. The switch classifies the subscribers into active subscribers A, B, and C and non-active subscribers D and E by monitoring the input traffic for a predetermined period of time in the subscriber determining operation 220. The switch calculates that the bandwidth of the input traffic currently being used by the active subscribers A, B, and C is 45 in the set rate-limiting calculating operation 230.

Since the bandwidth of 45 of the input traffic currently being used is larger than the allowable switch output maximum capacity of 40, the switch predicts the occurrence of congestion in the rate-limiting comparing operation 240. The switch resets the rate-limiting value of all the subscribers to 13 in the rate-limiting value resetting operation 250. The switch limits the input traffic according to the rate-limiting value of the subscribers set in the rate-limiting operation 260.

After a predetermined time Δt1, at a specific time k+Δt1, the switch classifies the subscribers into active subscribers A and C and non-active subscribers B, D, and E by monitoring the input traffic for a predetermined period of time in the subscriber determining operation 220. The switch calculates that the bandwidth of the input traffic currently being used by the active subscribers A and C is 26 in the set rate-limiting calculating operation 230.

Since the bandwidth of 26 of the input traffic currently being used is larger than the allowable switch output minimum capacity of 25, the switch predicts that the congestion will not occur in the rate-limiting comparing operation 240. Since the congestion does not occur, the switch maintains a current state in the rate-limiting resetting operation 250. The switch limits the input traffic according to the rate-limiting value for the subscribers set in the rate-limiting operation 260.

After a predetermined time Δt2, at a specific time k+Δt2, the switch classifies the subscribers into active subscribers A, C, D, and E and non-active subscribers B by monitoring the input traffic for a predetermined period of time in the subscriber determining operation 220. The switch calculates that the bandwidth of the input traffic currently being used by the active subscribers A, C, D, and E is 52 in the set rate-limiting calculating operation 230.

Since the bandwidth of 52 of the input traffic currently being used is larger than the allowable switch output maximum capacity of 40, the switch predicts the occurrence of congestion in the rate-limiting comparing operation 240. The switch resets the rate-limiting value of all the subscribers to 10 in the rate-limiting value resetting operation 250. The switch limits the input traffic according to the rate-limiting value of the subscribers set in the rate-limiting operation 260.

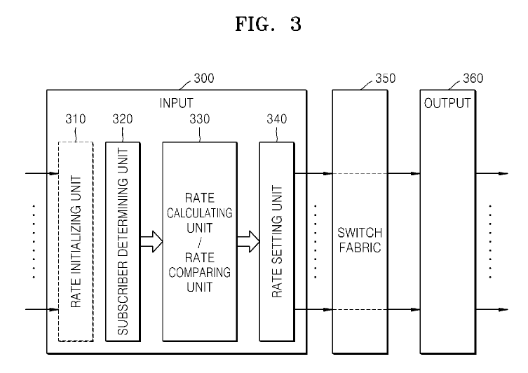

FIG. 3 is a structural view showing a system for implementing a rate-limiting method used in a switch, according to an embodiment of the present invention. Referring to FIG. 3, a switch rate-limiting apparatus includes an input terminal 300 including a rate initializing unit 310, a subscriber determining unit 320, a rate calculating/rate comparing unit 330, and a rate setting unit 340, a switch 350, and an input terminal 360.

The rate initializing unit 310 sets traffic bandwidths of subscribers connected to the switch 350 to predetermined initial values.

The subscriber determining unit 320 classifies the subscribers connected to the switch into active subscribers that are currently using the switch and non-active subscribers that are not currently using the switch.

The rate calculating unit 330 adds all of the traffic bandwidths predetermined for use by the active subscribers that are currently using the switch from among the subscribers connected to the switch.

The rate comparing unit 330 compares the added value with a total traffic rate range corresponding to a region of switching packets set in the switch.

According to the result of comparing, when the added value is outside the total traffic rate range, the rate setting unit 340 resets the traffic bandwidths of the active subscribers so that the added value is within the total traffic rate range set in the switch.

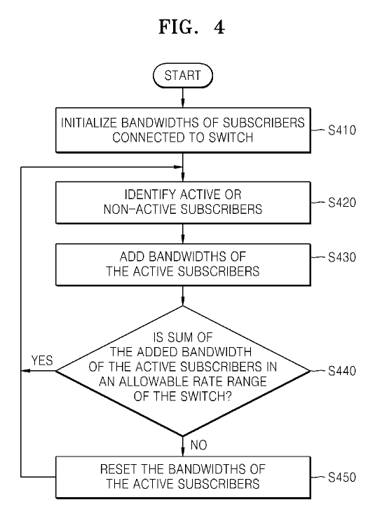

FIG. 4 is a flowchart of a method of limiting the traffic bandwidths of active subscribers, according to an embodiment of the present invention.

When a subscriber is connected to the switch, traffic bandwidth that can be used by the subscriber is initialized (operation S410). It is determined whether or not the subscriber uses the switch (operation S420) and traffic bandwidths allocated to active subscribers are added together (operation S430).

It is determined whether or not the sum of the traffic bandwidths allocated to the active subscribers is in a range between a maximum value and a minimum value of the total traffic rate range of the switch (operation 440). First, when the sum is in the total traffic rate range, the active subscribers transmit traffic signals to the output port and return to operation S420. When the sum is not in the total traffic rate range, the maximum value of the total traffic rate range is redistributed to the active subscribers according to a predetermined ratio so as to reset the traffic bandwidths of the active subscribers (operation S450), and the traffic signals of the active subscribers are transmitted to the output port.

Accordingly, input traffic is monitored for a predetermined period of time in order to determine subscribers that are currently using a switch and the total bandwidth and so as to be compared with an allowable switch output capacity, so that it is possible to automatically control rate-limiting traffic.

In addition, the rate-limiting traffic is automatically controlled according to the total bandwidth currently being used, so that it is possible to remove congestion that can occur in the output port in advance.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A dynamic rate-limiting method used in a switch for switching packets from input ports to output ports, the method comprising:
(a) adding traffic bandwidth values set in advance in active subscribers that are using the switch from among subscribers connected to the switch;
(b) comparing the added value with a range between a maximum bandwidth and a minimum bandwidth that are set in the switch; and
(c) according to a result of comparing, when the added values is smaller than the minimum bandwidth or larger than the maximum bandwidth set in the switch, increasing or decreasing the traffic bandwidths of the active subscribers set in advance so that the added value is within the range between the maximum bandwidth and minimum bandwidth.

2. The method of claim 1, wherein in (a), a subscriber of the subscribers connected to the switch is connected to each of the input ports, or several subscribers are connected to a single input port.

3. The method of claim 1, further comprising, before (a), (a-0) setting the traffic bandwidths of the subscribers connected to the switch as predetermined initial values.

4. The method of claim 1, further comprising, before (a), (a-1) monitoring the input traffic of subscribers from among the subscribers connected to the switch for a predetermined period of time to determine the active subscribers that have the input traffic.

5. The method of claim 1, wherein (c) returns to (a) after increasing or decreasing the traffic bandwidths of the active subscribers.

6. The method of claim 1, wherein in (c), traffic bandwidths of the active subscribers are increased or decreased to values obtained by distributing the maximum value of a total traffic rate range of the switch at a predetermined ratio according to the number of the active subscribers.

7. A dynamic rate-limiting apparatus used in a switch for switching packets from input ports to output ports, the apparatus comprising:
a rate calculating unit adding all of traffic bandwidth values set in advance in active subscribers that are using the switch from among subscribers connected to the switch;
a rate comparing unit comparing the added value with a range between a maximum bandwidth and a minimum bandwidth that are set in the switch; and
a rate setting unit increasing or decreasing the traffic bandwidths of the active subscribers set in advance so that the added value is within the range between the maximum bandwidth and minimum bandwidth set in the switch when the added value is smaller than the minimum bandwidth or larger than the maximum bandwidth set in the switch according to a result of comparing.

8. The apparatus of claim 7, wherein in the rate calculating unit, a subscriber of the subscribers connected to the switch is connected to each of the input ports, or several subscribers are connected to a single input port.

9. The apparatus of claim 7, further comprising a rate initializing unit setting the traffic bandwidths of the subscribers connected to the switch as predetermined initial values.

10. The apparatus of claim 7, further comprising a subscriber determining unit monitoring the input traffic of subscribers from among the subscribers connected to the switch for a predetermined period of time to determine the active subscribers that have the input traffic.

11. The apparatus of claim 10, wherein in the rate setting unit operation returns to the subscriber determining unit after increasing or decreasing the traffic bandwidths of the active subscribers.

12. The apparatus of claim 7, wherein the rate setting unit increases or decreases the traffic bandwidths of the active subscribers to values obtained by distributing a maximum value of a total traffic rate range of the switch at a predetermined ratio according to the number of the active subscribers.
